(19) United States
(12) Patent Application Publication
(10) Pub. No.: US 2004/0182456 A1
(43) Pub. Date: Sep. 23, 2004

(54) Fluid distribution flow adjustment device

(76) Inventor: Guy Rousselin, Herry (FR)

Correspondence Address: LOWE HAUPTMAN GILMAN AND BERNER, LLP, 1700 DIAGONAL ROAD, SUITE 300 /310, ALEXANDRIA, VA, 22314, US

(21) Appl. No.: 10/671,866

(22) Filed: Sep. 29, 2003

(30) Foreign Application Priority Data
Mar. 18, 2003 (FR) 03 03576

(51) Int. Cl. F16K 3/02

(52) U.S. Cl. 137/625.3

(57) ABSTRACT

A fluid distribution flow adjustment installation comprises a body having a fluid inlet tube opening up at one end facing a turnable metallic disk. The disk has drilled holes with precise dimensions such that there (1) is always at least one of these holes facing an outlet tube formed in the body, regardless of the position of the disk to enable fluid distribution without any risk of interruption even during adjustment of the flow, and (2) gradual adjustment of the flow as a function of the diameter of the holes and/or the density of the holes facing the outlet tube.

### FIELD OF THE INVENTION

This invention relates to a fluid distribution flow adjustment device.

### BACKGROUND ART

Fluids distribution flow adjustment devices are known in which the fluid inlet tube opens up onto a disk drilled with a row of holes with increasing diameters that can be placed successively facing the fluid inlet tube using a knurled knob to enable a discrete and discontinuous increase in the fluid flow. This embodiment does not allow continuous, gradual increase and there is a risk of the flow being interrupted when none of the holes in the disk are facing the fluid inlet tube. This is a major disadvantage when the fluid for which the flow is being distributed is a vital fluid for a living being.

The purpose of the invention is to propose a flow adjustment device with the advantage that it enables a more gradual flow adjustment without any risk of interrupting the flow.

### SUMMARY OF THE INVENTION

This purpose is obtained by the fact that the fluid distribution flow adjustment installation comprises a body provided with a fluid inlet tube opening up at one end facing a metallic disk driven in rotation by drive means, and through which holes are drilled such that there is always at least one of these holes facing an outlet tube formed in the body, regardless of the position of the disk to enable fluid distribution without any risk of interruption even during adjustment of the flow, and gradual adjustment of the flow as a function of the diameter of the hole(s) and/or the density of the holes facing the outlet tube.

According to another feature, the disk is drilled with at least two concentric rows of holes with precise dimensions, and in which the holes in each row are arranged at a regular angular spacing and are at different angles with respect to the holes in the other row, the diameter of the holes encountered in sequence in a given rotation direction varying progressively for each successive hole belonging to the two different rows and at adjacent angles, the spacing between successive holes in the two rows being less than the diameters of the fluid inlet and outlet tubes in the body, the fluid inlet or outlet tube facing several holes in the disk associated with drive means to enable gradual flow adjustment without any risk of interrupting the fluid flow.

According to another feature, the disk comprises a single continuous cutout over an angular sector and with a circular axis of symmetry for which the width varies progressively with the angle of the radius of intersection of the cutout.

According to another feature, the drive means is a knob rotating in the body and fixed in rotation with the metallic disk to rotate the disk to adjust the flow, a drilling in the knob being provided to enable circulation of the fluid as far as the precision holes in the metallic fluid flow adjustment disk.

According to another feature, a drilling in a lower part of the body forms the fluid outlet tube for which the diameter is greater than the spacing between at least two precision holes in the same row in the disk to assure that the outlet tube is always facing at least two precision holes in the metallic flow adjustment disk.

According to another feature, the installation is sealed by O-rings arranged in grooves formed on the periphery of the cylindrical surface of the knob, and also on the internal peripheral surface of the skirt of the knob and on the corresponding lower and upper parts of the body containing the inlet tube and on the outlet tube respectively, and finally a seal placed in a drilling with a larger diameter than the fluid outlet tube.

According to another feature, the seal is achieved by two O-rings, one placed between the disk and outlet tube, and the other placed between the disk and the inlet tube, both in drillings with a diameter larger than their corresponding tubes and facing the hole(s) and each other.

According to another feature, the rotating knob is knurled on its outside surface and projects on at least one face of the body so that it can be turned manually.

According to another feature, the body is made from two moulded plastic parts, at least partially enclosing the knob and the disk.

According to another feature, the diameter of the disk is less than the diameter of the knob.

According to another feature, the orifices facing the disk are facing at least two holes.

### BRIEF DESCRIPTION OF THE DRAWING

Other features and advantages of this invention will become clearer after reading the following description given with reference to the attached drawings in which:

FIG. 1a is a sectional view of a preferred embodiment of a flow adjustment device including a knurled knob and parts of a body forming fluid inlet and outlet passages;

FIG. 1b is a top view of the structure of FIG. 1a;

FIG. 1c is a front view of the complete flow adjustment of the structure of FIG. 1a;

FIG. 2 is a top view of one embodiment of a metallic fluid distribution flow adjustment disk that can be included in the device of FIG. 1;

FIG. 3 is a top view of a second embodiment of metallic fluid distribution flow adjustment disk that can be included in the device of FIG. 1 wherein the disk includes a single cut out continuous around an angular sector and with a circular axis of symmetry with a width that varies progressively with the angle of the radius of intersection of the cutout;

FIGS. 4a, 4b and 4c are respectively a side sectional view, a side view and a top view of the knurled knob of the device of FIG. 1;

FIGS. 5a and 5b are respectively a bottom view and a side sectional view (taken through the lines 5B-5B) of the top part of the body including a fluid inlet passage;

FIGS. 6a and 6b are respectively a top view and a side sectional view (taken through the lines 6B-6B) of the lower part of the body including the fluid outlet passage;

FIGS. 7a and 7b are respectively a top view and a side sectional view (taken through the lines D-D) of another embodiment of the invention wherein the disk is between O-rings in the inlet and outlet passages.

### DETAILED DESCRIPTION OF THE DRAWING

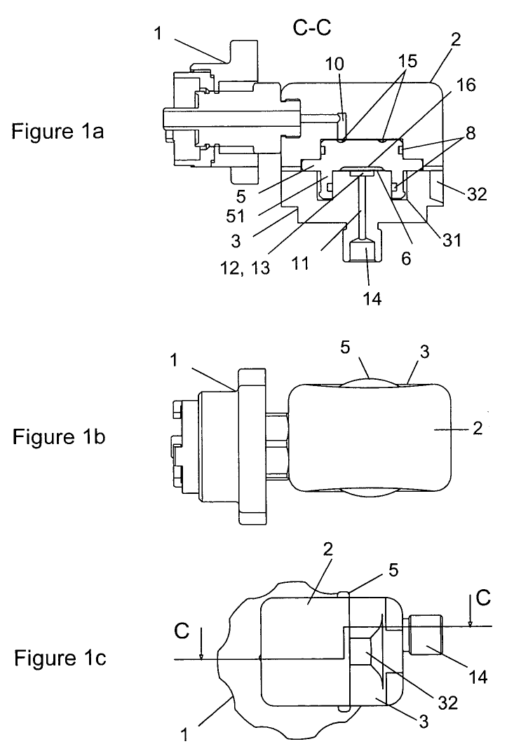

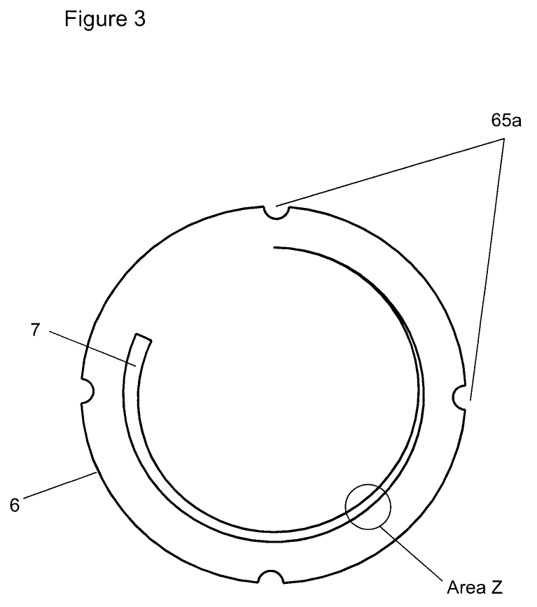

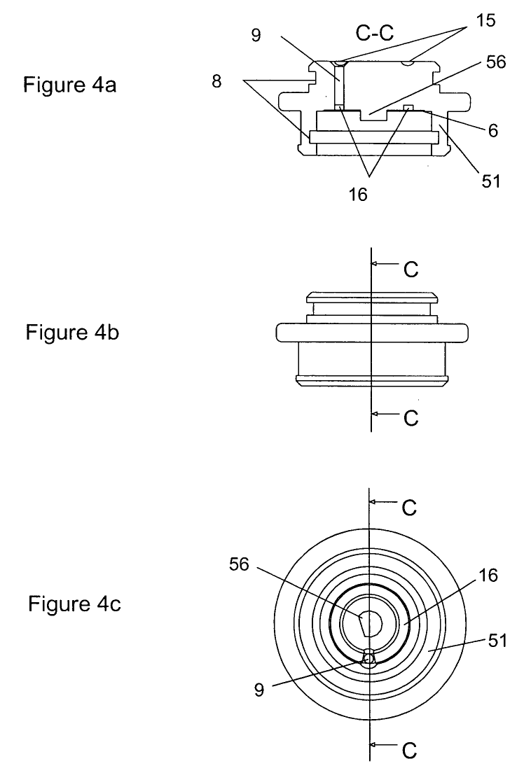

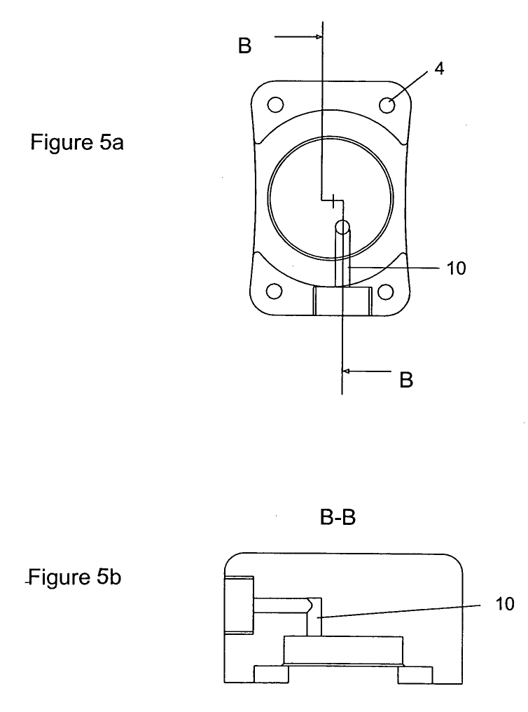

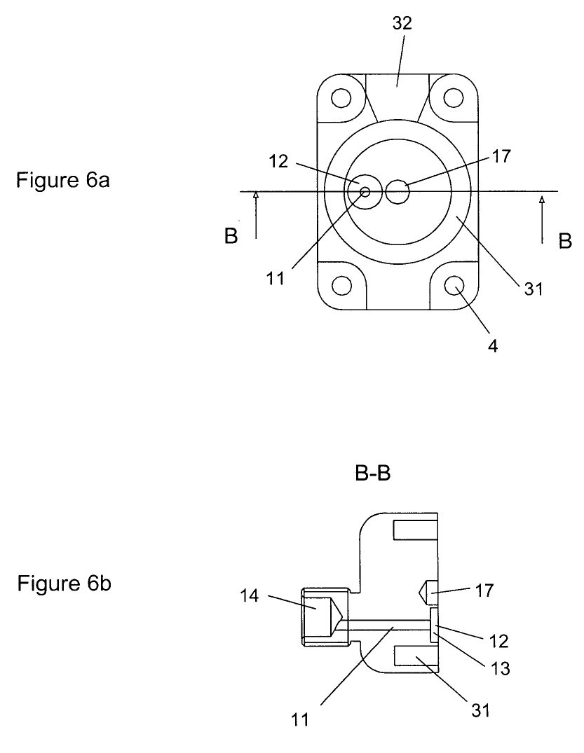

The fluid distribution flow adjustment device illustrated in FIGS. 1-7 includes an adaptor (1, FIG. 1a) arranged to be mounted on gas sources and opening up to an upper fluid inlet body (2), for example a rectangular shaped body, fixed to a lower fluid outlet body (3) by screws at its four corners (4), by clipping, gluing or welding. Abutting faces of bodies 2 and 3 have the same shape and dimensions. A cylindrical knob (5) knurled around the outside of the cylinder is fixed in rotation with a metallic flow adjustment disk (6) having, for example, two rows (70, 71) of drilled holes (70₀-70ₙ and 71₀-71ₙ) with precisely defined increasing diameters. In the exemplary embodiment, the diameter of first and second adjacent holes in a row (70) increases monotonically in increments so that the diameters of the hole in the other row (71) between the first and second holes is between the diameters of the first and second holes. The bottom face of knob (5) includes a cylindrical stub having a cross-section with a complementary shape to a cut out (65, 65a) on the disk or vice versa, whereby the disk is fixedly carried by the knob. The knurled knob (5) is rotated with respect to the body (3) as a result of body (3) including a drilled hole (17) into which stub (56) of knob (5) is inserted, or vice versa, and by the lower face of the knob (5) including an extension in the form of a skirt (51), co-operating with a complementary shaped groove (31) formed in the part of the body (3) facing the face of the knob (5) on which the skirt is formed. A notch (32) is formed on one of the faces of the body (3) facing the knob face on which the skirt (51) is formed, for example to make the skirt of the knurled knob visible and so that the required flow reading can be made. The knurled knob (5) is installed in a leak tight manner between the fluid inlet body (2) and outlet body (3) the leak tight manner is achieved by O-rings placed in each groove (8) formed in the wall of knurled knob (5) on each side of the circulation grooves (15, 16), respectively formed on the upper and lower faces of the knurled knob. A passage (9) is drilled in the knurled knob (5) opening out onto the two circulation grooves (15 and 16). Passage (9) enables fluid circulation between the inlet passage (10) and the precision holes (70, 71) in the metallic flow adjustment disk facing the fluid outlet passages (11). The fluid outlet passage (11) is formed by drilling a bore between opposite upper and lower faces of the fluid outlet body (3) and opens up onto the flow adjustment disk (6) through circular indentation or recess in the upper face of body (3). The circular indentation has a larger diameter than passage 11 and smaller diameter than disk (6). Indentation (12) carries circular seal (13) that makes a leak tight joint between the disk (6) and the outlet passage (11), while leaving an opening with a sufficient diameter to enable an area Z of the disk to communicate with the outlet passage (11). The end of fluid outlet passage (11) opposite from seal (13) opens up onto a region (14) forming a connector for a fluid distribution pipe.

In a first embodiment of the invention, the size of the holes (70, 71) in disk (6) opposite the area Z leading towards the outlet passage (11) increases gradually.

In a second embodiment, the diameter of the holes remains constant but their density facing the area Z varies gradually.

In a third embodiment, the diameter and the density of the holes vary.

In a fourth embodiment, the disk (6) comprises a single continuous cut out (7) over an angular sector. Cut out (7) has a circular axis of symmetry over which the width of the cut out varies gradually with the angle of the radius of intersection of the cut out, such that the surface area of the cut out facing the area Z varies gradually.

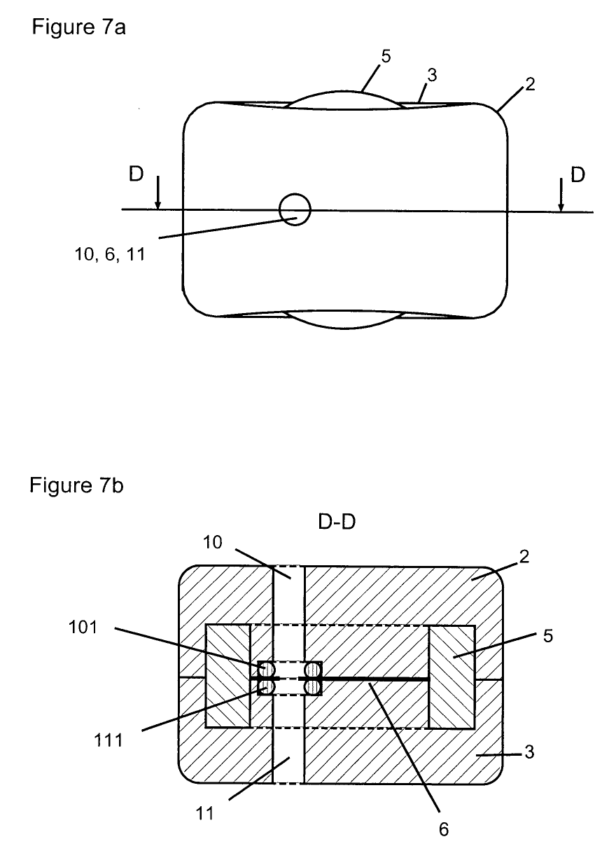

In the embodiment illustrated in FIG. 7b the disk (6) is clamped between O-rings (101, 111) respectively seated in grooves of inlet passage (10) and the outlet passage (11). O-rings (101, 111) face the holes (70, 71) or the cut out in disk (6) and each other.

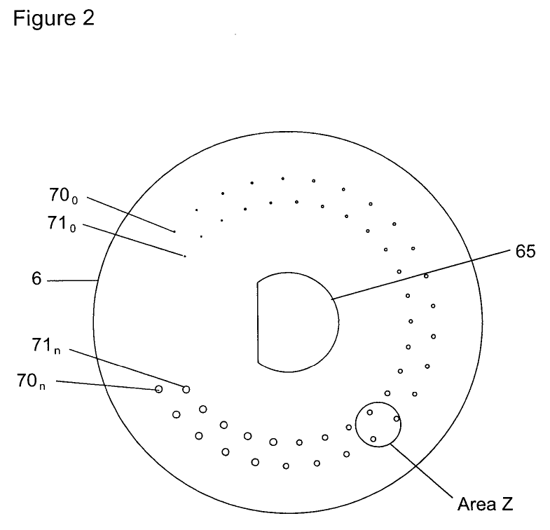

The area Z, as shown in FIG. 2, is such that two or more holes in a single row and/or in different rows always face the area Z. Therefore, the size of the area Z corresponds to at least the maximum interval between two adjacent holes, regardless of the direction in which the holes are located.

During operation, the fluid is transferred through the inlet passage (10) opening up onto a groove (15) formed in the knurled knob (5) that enables fluid circulation as far as the passage (9) in the knurled knob opening up into a groove (16) on the other side of the knurled knob, facing the two rows (70, 71) of precision holes in the metallic flow adjustment disk (6) onto which the fluid outlet tube (11) opens up. The seal between the knurled knob (5) and the fluid inlet body (2) and outlet body (3) is made on each side (8) of the passage (9) in the knurled knob such that all the fluid circulates through passage (9) in the knurled knob. The diameter of the knurled knob (5) is greater than the width of the inlet body (2) and the outlet body (3) so that the user can rotate the knurled knob (5) fixed to the adjustment disk (6) in order to adjust the fluid flow by placing several precision holes (70, 71) with different diameters facing the fluid outlet passage (11), having a diameter greater than the space between two precision holes in the disk.

It will be understood that the resulting product is a fluid distribution flow adjustment device enabling gradual adjustment without any risk of the fluid flow being interrupted.

The seals made with the O-rings and a JF4 No. 2 seal placed in the grooves can be replaced by any other sealing system satisfying usage conditions without going outside the scope of the invention.

In a second embodiment, the diameter of the holes remains constant but their density facing the area Z varies gradually.

In a third embodiment, the diameter and the density of the holes vary.

Persons of ordinary skill in the art will find it obvious that this invention can be used with embodiments in many other specific forms without going outside the scope of the invention as claimed. Consequently, these embodiments must be considered as being provided for illustration purposes, and they can be modified within the scope of the attached claims, and the invention must not be limited to the details given above.

1. Fluid distribution flow adjustment device comprising a first body having a fluid inlet passage, a second body having a fluid outlet passage, the fluid inlet passage opening up at one end facing a turnable disk having holes, the disk and outlet passage being arranged so that there is always at least one of the holes facing the outlet passage, regardless of the position of the disk, to enable fluid distribution without any risk of interruption even during adjustment of the flow in response to turning of the disk, the disk and the outlet passage being arranged so gradual adjustment of the flow is adapted to occur in response to gradual turning of the disk as a function of at least one of (1) the diameter of at least one of the holes and (2) the density of the holes facing the outlet passage.

2. Fluid distribution flow adjustment device according to claim 1, wherein the disk comprises a single continuous cut out around an angular sector with a circular axis of symmetry, the width of the cut out varying gradually with the angle of the radius of intersection of the cut out.

3. Fluid distribution flow adjustment device according to claim 1, wherein the disk includes at least two concentric rows of holes with precise dimensions, the holes in each row being offset from the holes in the other row and at a regular angular spacing, the diameter of the holes encountered in sequence in a given rotation direction varying gradually for each successive hole of two different adjacent rows, the spacing between successive holes in two adjacent rows being less than the diameters of the fluid inlet passage and outlet passage, the fluid outlet or inlet passage facing several holes in the disk to enable gradual flow adjustment without any risk of interrupting the fluid flow.

4. Fluid distribution flow adjustment device according to claim 1, further including a drive for turning the disk, the drive including a knob adapted to turn in at least one of the bodies and fixed in rotation with the disk so that the knob can be turned to adjust the flow, the knob including a passage for enabling fluid circulation as far as the precision holes or cut out in the fluid flow adjustment disk.

5. Fluid distribution flow adjustment device according to claim 1, wherein a lower part of the second body includes the fluid outlet passage, the outlet passage having a diameter greater than the spacing between at least two adjacent precision holes in the same row in the disk to assure that the outlet passage is always facing at least two precision holes in the flow adjustment disk.

6. Fluid distribution flow adjustment device according to claim 1, wherein the installation is made leak tight by O-rings arranged in grooves around the periphery of the cylindrical surface of the knob, and on the internal peripheral surface of a skirt of the knob and the lower part and upper part of the body containing the inlet tube and the outlet tube respectively, and by an O-ring placed between the disk and the outlet tube in a larger diameter drilling than the fluid outlet tube.

7. Fluid distribution flow adjustment device according to claim 1, further including a seal between the disk and the inlet and outlet passage, the seal including first and second O-rings, the first O-ring being in contact with a first face of the disk and seated in a wall of the first passage, the second O-ring being in contact with a second face of the disk and seated in a wall of the second passage between the disk and the outlet passage, the second O-ring being located between the disk and the inlet passage, both in drillings with a diameter larger than their corresponding tubes and facing the hole(s) or the cut out and each other.

8. Fluid distribution flow adjustment device according to claim 1 wherein the knob is knurled on its external periphery and is arranged on at least one face of one of the bodies so that it can be turned manually.

9. Fluid distribution flow adjustment device according to claim 1 wherein the first and second bodies are formed of moulded plastic and at least partially enclose the knob and the disk.

10. Fluid distribution flow adjustment device according to claim 1 wherein the diameter of the disk is smaller than the diameter of the knob.
